(19) United States
(12) Patent Application Publication
(10) Pub. No.: US 2022/0070016 A1
(43) Pub. Date: Mar. 3, 2022

(54) METHOD AND APPARATUS FOR DYNAMICALLY BUILDING CONFLICT CHECK RULE TABLE IN SMART HOME

(71) Applicant: BEIJING MORAN COGNITIVE TECHNOLOGY CO., LTD., Beijing (CN)

(72) Inventors: Shuaixiang Dai, Beijing (CN); Bo Fan, Beijing (CN); Guohua Li, Beijing (CN); Weimeng Zhang, Beijing (CN); Zhiwei Yuan, Beijing (CN)

(21) Appl. No.: 17/418,777

(22) PCT Filed: Dec. 25, 2019
(86) PCT No.: PCT/CN2019/128247

§ 371 Date: Jun. 25, 2021

(30) Foreign Application Priority Data
Dec. 26, 2018 (CN) 201811601888.9

(51) Int. Cl. H04L 12/28; H04W 76/10

(52) U.S. Cl. CPC H04L 12/2821; H04L 67/12; H04W 76/10; H04L 12/2807

(57) ABSTRACT

A method for dynamically building a conflict check rule table in smart home comprises: sending (101) a smart home network access request to a cloud server by first smart home device, when accessing a smart home network for the first time; obtaining (103) one or more second smart home devices having accessed the smart home network by the cloud server; searching (104) for second smart home service conflicting with the first smart home device in one or more second smart home services recording to second conflict check rule table stored therein, and adding a search result to first conflict check rule table corresponding to the smart home network by the cloud server. The method can avoid waste of electricity and the reduction of service life of the smart home device, and avoid unnecessary conflict check, thereby accelerating the response speed of the conflict check and improving the user experience.

### CROSS-REFERENCE TO RELATED APPLICATION

This disclosure claims priority to Chinese Patent Application No. 201811601888.9 filed in the China Patent Office on Dec. 26, 2018, entitled “a method and apparatus for dynamically building a conflict check rule table in smart home”, the disclosure of which is hereby incorporated by reference in its entirety.

### TECHNICAL FIELD

The embodiments of the present disclosure relate to the field of smart home, and more specifically, to a method and apparatus for dynamically building a conflict check rule table in smart home.

### BACKGROUND

With the advent of the era of Internet intelligence, intelligent control technologies and information technologies have developed rapidly, with the popularity of various mobile smart terminals, intelligence has gradually been applied to traditional household device, the concept of smart home has gradually entered the life of users, and the users can control the smart devices at home through their mobile terminals, which makes the life of users more convenient.

In actual use, there may be conflicts between the control instructions issued by the user, for example, the user finds that the weather is particularly good after going out, and thus opens the window by remote control, but prior to returning home at night, the user turns on the air conditioner by remote control, but forgets to issue, at the same time, an instruction to close the windows, at this time, since the air conditioner is in a turning on state and the windows are in an open state, on the one hand, it will waste electricity and reduce the service life of the air conditioner, on the other hand, because the windows are open, the air conditioner cannot quickly adjust the indoor temperature to the temperature required by the user, which affects the user experience.

In addition, in a smart home network, there are often multiple mobile terminals, and different family members use different mobile terminals to control the smart devices in the smart home network, at this time, conflicts between devices are also prone to occur, such as, a family member 1 is preparing to watch a movie through the projector at home, and sends an instruction to turn on the projector, and a family member 2 remotely issues an instruction to turn on the living room lamp, at this time, the projector and the lamp are in a turning on state at the same time, and the lights will affect the projection effect of the projector, and in turn affects the user experience.

It can be seen that in the control of smart devices, due to various reasons, conflicts between the working states of multiple smart devices in the smart home network are prone to conflicts, and it is necessary to check whether there is a conflict between the running states of smart home devices.

### SUMMARY

In view of the above-mentioned problems in the prior art, the present disclosure proposes a method and apparatus for dynamically building a conflict check rule table in smart home.

The embodiments of the present disclosure provide a method for dynamically building a conflict check rule table in smart home, including:

sending a smart home network access request to a cloud server, by a first smart home device, when accessing a smart home network for the first time;

returning an access response to the first smart home device by the cloud server, and establishing a connection with the cloud server by the first smart home device to successfully access the smart home network;

obtaining one or more second smart home devices having accessed the smart home network by the cloud server; and

searching for a second smart home device conflicting with the first smart home device in the one or more second smart home devices according to a second conflict check rule table stored therein, and adding a search result into a first conflict check rule table corresponding to the smart home network, by the cloud server;

wherein the first conflict check rule table is used specifically to: when receiving a user's instruction for a certain smart home device, prior to specifically executing the instruction, determine at first whether a state of the smart home device conflicts with states of other smart home devices after the instruction is executed, and execute the instruction when there is no conflict.

The embodiments of the present disclosure provide an apparatus for dynamically building a conflict check rule table in smart home, and the apparatus includes:

an access request receiving module, configured to receive a smart home network access request sent by a first smart home device when the first smart home device accesses the smart home network for the first time;

an access response sending module, configured to return an access response to the first smart home device, and establish a connection with the first smart home device, to enable the first smart home device to successfully access the smart home network;

a first obtaining module, configured to obtain one or more second smart home devices having accessed the smart home network;

a dynamic building module, configured to search for a second smart home device conflicting with the first smart home device in the one or more second smart home devices according to a second conflict check rule table, and add a search result to a first conflict check rule table corresponding to the smart home network;

a first storage module, configured to store the second conflict check rule table;

wherein the first conflict check rule table is used specifically to: when receiving a user's instruction for a certain smart home device, prior to specifically executing the instruction, determine at first whether a state of the smart home device conflicts with states of other smart home devices after the instruction is executed, and execute the instruction when there is no conflict.

Preferably, the apparatus further includes a second storage module having stored therein a smart home device list of the smart home network in which one or more second smart home devices having accessed the smart home network are stored; and

the first obtaining module is configured to obtain one or more second smart home devices having accessed the smart home network according to the smart home device list.

Preferably, the dynamic building module is configured to search in a second conflict check rule table whether there is a conflict check rule involving the first smart home device and the one or more second smart home devices, and if so, add the conflict check rule into the first conflict check rule table of the smart home network.

Preferably, the second conflict check rule table includes one or more conflict check rules, and each conflict check rule corresponds to a row of the table, including four fields of a current smart home device, a working state of the current smart home device, a conflict smart home device and a working state of the conflict smart home device.

Preferably, the dynamic building module is specifically configured to perform the following steps for each of the one or more second smart home devices obtained by the first obtaining module:

for the first conflict check rule in the second conflict check rule table, performing a first judgment, that is, determining whether a field value of the current smart home is the first smart home device; if a result of the first judgment is no, continuing to make the first judgment for a next conflict check rule until all conflict check rules are determined; and if the result of the first judgment is yes, performing a second judgment, that is, determining whether a field value of the conflict smart home device is the second smart home device, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined; and

for the first conflict check rule in the second conflict check rule table, performing a third judgment, that is, determining whether the field value of the current smart home is the second smart home device; if a result of the third judgment is no, continuing to make the third judgment for the next conflict check rule until all conflict check rules are determined; and if the result of the first judgment is yes, performing a fourth judgment, that is, determining whether the field value of the conflict smart home device is the first smart home device, if a result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined

Preferably, the dynamic building module is specifically configured to:

for the first conflict check rule in the second conflict check rule table, perform a first judgment, that is, determine whether a field value of the current smart home is the first smart home device, if a result of the first judgment is no, continue to make the first judgment for a next conflict check rule until all conflict check rules are determined; and if the result of the first judgment is yes, perform a second judgment, that is, determine whether a value of the conflict smart home device in the conflict check rule belongs to the one or more second smart home devices, if a result of the second judgment is yes, add the conflict check rule into the first conflict check rule table of the smart home network, and continue to make the first judgment for the next conflict check rule until all conflict check rules are determined, and if the result of the second judgment is no, continue to make the first judgment for the next conflict check rule, until all conflict check rules are determined; and

for the first conflict check rule in the second conflict check rule table, perform a third judgment, that is, determine whether a field value of the conflict smart home is the first smart home device, if a result of the third judgment is no, continue to make the third judgment for the next conflict check rule until all conflict check rules are determined; and if the result of the third judgment is yes, perform a fourth judgment, that is, determine whether a value of the current smart home device in the conflict check rule belongs to the one or more second smart home devices, if a result of the fourth judgment is yes, add the conflict check rule into the first conflict check rule table of the smart home network, and continue to make the third judgment for the next conflict check rule until all conflict check rules are determined, and if the result of the fourth judgment is no, continue to make the third judgment for the next conflict check rule until all conflict check rules are determined.

Preferably, the second conflict check rule table and the first conflict check rule table have the same data structure.

Preferably, the dynamic building module is specifically configured to perform the following processes for each of the one or more second smart home devices obtained by the first obtaining module:

for the first conflict check rule in the second conflict check rule table, performing a first judgment, that is, determining whether a field value of the current smart home is the first smart home device; if a result of the first judgment is no, continuing to make the first judgment for a next conflict check rule until all conflict check rules are determined; and if the result of the first judgment is yes, performing a second judgment, that is, determining whether a field value of the conflict smart home device is the second smart home device, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;

wherein, adding the conflict check rule into the first conflict check rule table of the smart home network specifically includes:

filling values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

Preferably, the dynamic building module is specifically configured to:

for the first conflict check rule in the second conflict check rule table, perform a first judgment, that is, determine whether a field value of the current smart home is the first smart home device, and if a result of the first judgment is no, continue to make the first judgment for a next conflict check rule until all conflict check rules are determined; and if the result of the first judgment is yes, perform a second judgment, that is, determine whether a value of the conflict smart home device in the conflict check rule belongs to the one or more second smart home devices, if a result of the second judgment is yes, add the conflict check rule into the first conflict check rule table of the smart home network, and continue to make the first judgment for the next conflict check rule until all conflict check rules are determined, and if the result of the second judgment is no, continue to make the first judgment for the next conflict check rule until all conflict check rules are determined;

wherein, adding the conflict check rule into the first conflict check rule table of the smart home network specifically includes:

filling values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

Preferably, the apparatus further includes a second obtaining module and a de-duplicating and sorting module, wherein the second obtaining module is configured to obtain the first conflict check rule tables of other smart home networks; and the de-duplicating and sorting module is configured to de-duplicate and sort the first conflict check rule tables of other smart home networks to form a second conflict check rule table.

Preferably, the device further includes a regularly synchronizing module, the regularly synchronizing module is configured to regularly inquire whether a new conflict check rule has been added to the first conflict check rule table of all smart home networks, and if so, the new conflict check rule is added into the second conflict check rule table.

Preferably, the device further includes a real-time synchronizing module, and the real-time synchronizing module is configured to add, when it is detected that a new conflict check rule is added to the first conflict check rule table of a certain smart home network, the new conflict check rule into the second conflict check rule table in real time.

Preferably, the apparatus further includes a third storage module and a first update module, wherein the third storage module is configured to store a smart home device function table; and

the first update module is configured to generate a second conflict check rule supplementary table by the cloud server according to the smart home device function table, and update the second conflict check rule table according to the second conflict check rule supplementary table.

Preferably, each row of the smart home device function table corresponds to a function of a smart home device, and each row includes the following fields: a smart home device, a working state, an influencing parameter, and an influencing result; wherein the functions of the smart home devices are represented by two fields of the influencing parameter and the influencing result.

Preferably, the first update module is specifically configured to perform the following operations for each row of the smart home device function table:

calling corresponding field values as a first smart home device, a first influencing parameter, a first influencing result, and a first working state, and determining whether there are other rows in the smart home device function table that have a serial number greater than this row and meet the following conditions, the field values corresponding to the other rows being called a second smart home device, a second influencing parameter, a second influencing result, and a second working state:

(1) the first influencing parameter and the second influencing parameter are the same;

(2) the first influencing result is opposite to the second influencing result;

(3) the first smart home device is different from the second smart home device;

if there are such other rows, writing the first smart home device, the first working state, the second smart home device, and the second working state into the fields of the current smart home device, the working state of the current smart home device, the conflict smart home device, and the working state of the conflict smart home device in the second conflict check rule supplementary table, respectively, to form a new conflict check rule, and writing the first smart home device, the first working state, the second smart home device, and the second working state into the fields of the conflict smart home device, the working state of the conflict smart home device, the current smart home device, and the working state of the current smart home device in the second conflict check rule supplementary table, respectively, to form another new conflict check rule.

Preferably, the first update module is specifically configured to determine whether the conflict check rules in the second conflict check rule supplementary table are contained in the second conflict check rule table, if not, add them into the second conflict check rule table.

Preferably, the apparatus further includes a second update module, configured to update the smart home device function table regularly or in real time according to a product catalog and product manual of each smart home device manufacturer.

Preferably, the apparatus is located in a cloud server.

The embodiments of the present disclosure provide a system for dynamically building a conflict check rule table in smart home, which includes one or more smart terminals, the above-mentioned apparatuses, and multiple smart devices.

The embodiments of the present disclosure provide a computer device that includes a processor and memory, and the memory stores computer instructions that can be executed by the processor, when the processor executes the computer instructions, the foregoing methods can be implemented.

The embodiments of the present disclosure provide a computer-readable storage medium for storing computer instructions used to implement the method described above.

Through the method, apparatus, and system of the present disclosure, after a new smart home device joins the network, the cloud server dynamically updates the conflict check rule table of the smart home network, such that when the user issues an instruction to control the smart home device, prior to actually executing the instruction, it is determined at first whether the state of the smart home device conflicts with the current states of other smart home devices after executing the instruction, thereby avoiding the waste of electricity and the reduction of service life of the smart home device, and further improving the user experience. In addition, when specifically updating the conflict check rule table, it is only considered whether the smart home device that has accessed the network conflicts with the smart device by searching, for the smart home devices that conflict with the smart home device but are not included in the current smart home network, they are not recorded in the conflict check rule table of the smart home network, such that unnecessary conflict check can be avoided when the user issues instructions to control smart home devices, thereby accelerating the response speed of conflict check and further improving the user experience.

### BRIEF DESCRIPTION OF THE DRAWINGS

FIG. 1 is a smart home system to which the method and apparatus for dynamically building a conflict check rule table in the smart home of the present disclosure are applicable.

FIG. 2 is a method for dynamically building a conflict check rule table in an embodiment of the present disclosure.

FIG. 3 is a method for dynamically building a conflict check rule table in another embodiment of the present disclosure.

FIG. 4 is a method for dynamically building a conflict check rule table in another embodiment of the present disclosure.

FIG. 5 is a method for dynamically building a conflict check rule table in another embodiment of the present disclosure.

FIG. 6 is a method for dynamically building a conflict check rule table in another embodiment of the present disclosure.

FIG. 7 is a method for dynamically building a conflict check rule table in another embodiment of the present disclosure.

FIG. 8 is a method for dynamically building a conflict check rule table in another embodiment of the present disclosure.

FIG. 9 is a method for dynamically building a conflict check rule table in another embodiment of the present disclosure.

FIG. 10 is an apparatus for dynamically building a conflict check rule table in an embodiment of the present disclosure.

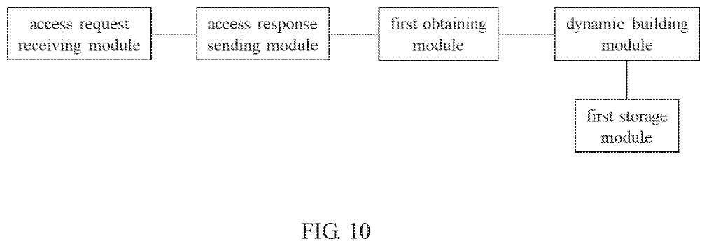

### DETAILED DESCRIPTION

In order to make the objectives, technical solutions, and advantages of the present disclosure clearer, the following further describes the embodiments of the present disclosure in detail with reference to the accompanying drawings.

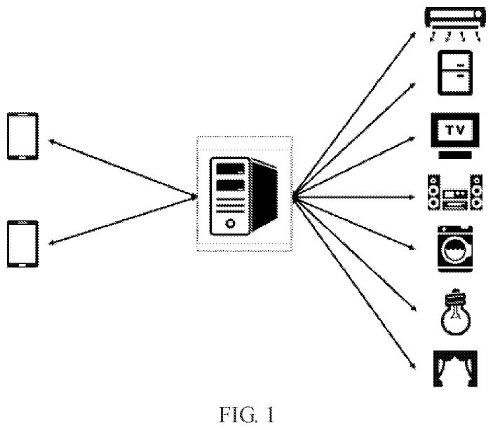

A method for dynamically building a conflict check rule table in smart home of the present disclosure is applied to the system as shown in FIG. 1, and the system includes a smart terminal, a cloud server, and smart devices.

Herein, there may be one or more smart terminals, which specifically can be terminals with a certain level of intelligence, such as mobile phones, PDAs, tablet computers, portable computers, and wearable devices.

The smart terminal receives user instructions and sends them to the cloud server. The smart terminal and the cloud server can be connected using a long-distance communication protocol such as a cellular network or a short-distance communication protocol such as Wi-Fi, Bluetooth, NFC, etc., which is not limited in the present disclosure. In an embodiment, the smart terminal may process the obtained user instruction before sending it to the cloud server, for example, when the user instruction is voice, the smart terminal may perform voice recognition on the user instruction and then send the same out to reduce the amount of data transmitted; and in another embodiment, the smart terminal may not perform the above processing, but directly send the obtained voice instruction to the cloud server, and the voice recognition is performed by the cloud server, which can reduce the processing load of the smart terminal on the one hand, and on the other hand, the accuracy is higher when the text conversion is performed by the cloud server. In another embodiment, if the user instruction can be recognized according to the locally stored voice instruction database, the smart terminal can perform text conversion for a part of the user instructions and then send them to the cloud server, and if the user instruction cannot be recognized according to the locally stored voice instruction database, the text conversion is not performed for the user instruction, and the acquired voice instruction is sent directly to the cloud server.

One or more smart terminals can have different control permissions, and when the instructions issued by different smart terminals for the same smart device are opposite, the system executes the instructions issued by the smart terminal with a high control permission; at this time, the system can also return prompt information to the smart terminal with low control permissions to prompt the user why the instruction has not been executed.

After receiving the user instruction from the smart terminal, the cloud server parses and processes the user instruction, determines the target smart device corresponding to the user instruction and the control action corresponding to the user instruction, and sends the control instruction carrying the control action to the target smart device.

The cloud server can also be a smart home gateway or a smart home router, and the above three terms have the same function in this disclosure and can be replaced with each other. The cloud server can be connected with smart devices through long-distance communication protocols such as cellular networks, and it can also be connected with smart devices through short-distance communication protocols, such as Wi-Fi, Bluetooth, NFC, and so on.

The smart devices, can specifically be smart doors and windows, smart projectors, smart humidifiers, smart air conditioners, smart air purifiers, smart sweeping robots, smart washing machines, smart curtains, smart TVs, smart speakers, etc.

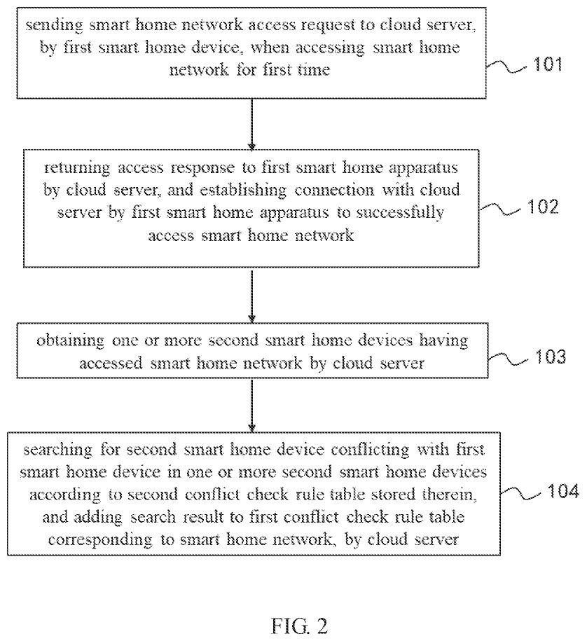

Subsequently, the method for dynamically building a conflict check rule table in the smart home of the present disclosure will be described, and referring to FIG. 2, the method includes the following steps:

in step 101, a smart home network access request is sent to a cloud server, by a first smart home device, when accessing a smart home network for the first time;

in step 102, an access response is returned to the first smart home device, by the cloud server and a connection with the cloud server is established by the first smart home device to successfully access the smart home network;

in step 103, one or more second smart home devices having accessed the smart home network is obtained by the cloud server; and

in step 104, the cloud server searches for a second smart home device conflicting with the first smart home device in the one or more second smart home devices according to a second conflict check rule table stored therein, and adds a search result to a first conflict check rule table corresponding to the smart home network;

wherein the first conflict check rule table is used specifically to: when receiving a user's instruction for a certain smart home device, prior to specifically executing the instruction, determine at first whether a state of the smart home device conflicts with the states of other smart home devices after the instruction is executed, and execute the instruction when there is no conflict.

Next, the above method will be described in detail.

Steps 101 to 102 are the processes of the first smart home device accessing the smart home network for the first time. The first smart home device sends an access request to the cloud server, and if the cloud server allows the first smart home device to access the smart home network, it returns an access response to the first smart home device, such that a connection is established between the two and the access process is completed. The cloud server can authenticate the first smart home device, and if the authentication is passed, it is allowed for the first smart home device to access the smart home network. The specific authentication process can use any authentication methods in the prior art, which is not limited in the present disclosure.

The cloud server stores a smart home device list of the smart home network, and the smart home device list stores one or more second smart home devices having accessed the smart home network, in step 103, the cloud server obtains one or more second smart home devices having accessed the smart home network according to the smart home device list. Herein, the one or more second smart home devices obtained by the cloud server are all second smart home devices having accessed the smart home network, when there is only one smart home device having accessed the smart home network, a second smart home device is obtained in step 103, and when there are multiple smart home devices having accessed the smart home network, multiple second smart home devices are obtained in step 103.

In addition, the cloud server also stores a second conflict check rule table, the second conflict check rule table includes one or more conflict check rules, and each conflict check rule corresponds to a row of the table, including four fields of a current smart home device, a working state of the current smart home device, a conflict smart home device, and a working state of the conflict smart home device.

Table 1 shows the second conflict check rule table in an embodiment of the present disclosure, the first row indicates that if an air conditioner is in a cooling state, it will conflict with windows/doors in an open state, that is, when the user issues an instruction of turning on the air conditioner and cooling, before the instruction is executed, it can be determined whether the state of the air conditioner, after the execution of the command, conflicts with the windows/doors, according to the first row of the second conflict check rule table. Similarly, the second row indicates that if the air conditioner is in a heating state, it will conflict with the windows/doors in the open state.

TABLE 1
Second Conflict Check Rule Table

| | | Working State of | | Working State of |
|---|---|---|---|---|
| Serial | Current Smart | Current Smart | Conflict Smart | Conflict Smart |
| Number | Home Device | Home Device | Home Device | Home Device |
| 1 | Air conditioner | Cooling | Windows/Doors | Open |
| 2 | Air conditioner | Heating | Windows/Doors | Open |
| 3 | Air conditioner | Dehumidification | Windows/Doors | Open |
| 4 | Windows/Doors | Open | Air conditioner | Cooling |
| 5 | Windows/Doors | Open | Air conditioner | Heating |
| 6 | Windows/Doors | Open | Air conditioner | Dehumidification |
| 7 | Air conditioner | Dehumidification | Humidifier | Turning on |
| 8 | Humidifier | Turning on | Air conditioner | Dehumidification |
| 9 | Projector | Turning on | Lamp | Turning on |
| 10 | Lamp | Turning on | Projector | Turning on |
| 11 | Humidifier | Turning on | Windows/Doors | Open |
| 12 | Windows/Doors | Open | Humidifier | Turning on |

Table 2 shows the second conflict check rule table in another embodiment of the present disclosure, the first row indicates that if the air conditioner is in a turning on state, it will conflict with the windows/doors in the open state, and there is no need to distinguish whether the current working state of the air conditioner is cooling, heating or dehumidification, and as compared to the second conflict check rule table shown in Table 1, the second conflict check rule table in Table 2 can save cloud server storage space and further improve the response speed of the conflict check, thereby improving the user experience.

TABLE 2
Second Conflict Check Rule Table

| | | Working State of | | Working State of |
|---|---|---|---|---|
| Serial | Current Smart | Current Smart | Conflict Smart | Conflict Smart |
| Number | Home Device | Home Device | Home Device | Home Device |
| 1 | Air conditioner | Turning on | Windows/Doors | Open |
| 2 | Windows/Doors | Open | Air conditioner | Turning on |
| 3 | Air conditioner | Dehumidification | Humidifier | Turning on |
| 4 | Humidifier | Turning on | Air conditioner | Dehumidification |
| 5 | Projector | Turning on | Lamp | Turning on |
| 6 | Lamp | Turning on | Projector | Turning on |
| 7 | Humidifier | Turning on | Windows/Doors | Open |
| 8 | Windows/Doors | Open | Humidifier | Turning on |

After the cloud server obtains one or more second smart home devices having accessed the smart home network through step 103, in step 104, the cloud server searches in the second conflict check rule table whether there is a conflict check rule involving the first smart home device and the one or more second smart home devices, if so, then the conflict check rule is added to the first conflict check rule table of the smart home network.

In an embodiment, step 104 is specifically: for each of the one or more second smart home devices obtained in step 103, performing the following two steps:

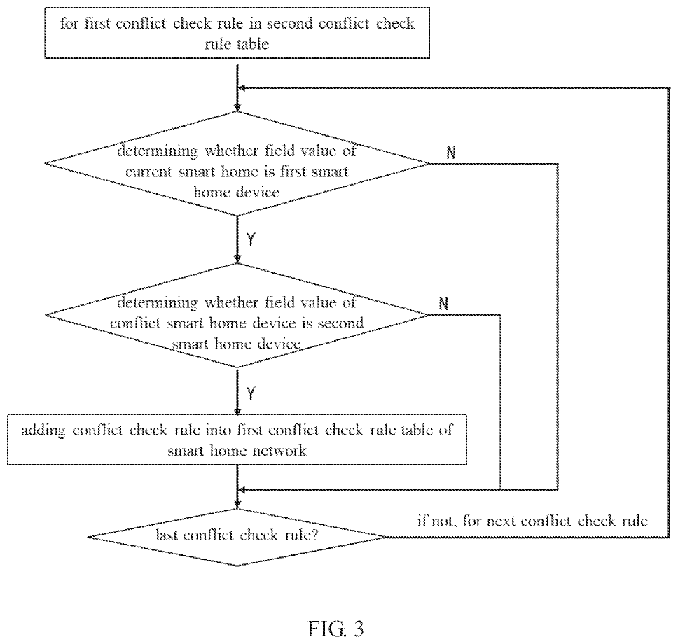

(1) for the first conflict check rule in the second conflict check rule table, performing a first judgment, that is, determining whether a field value of the current smart home is the first smart home device; if the result of the first judgment is no, continuing to make the first judgment for the next conflict check rule until all conflict check rules are determined; and if the result of the first judgment is yes, performing a second judgment, that is, determining whether the field value of the conflict smart home device is the second smart home device, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined, and the specific execution processes of the above step are referred to FIG. 3; and

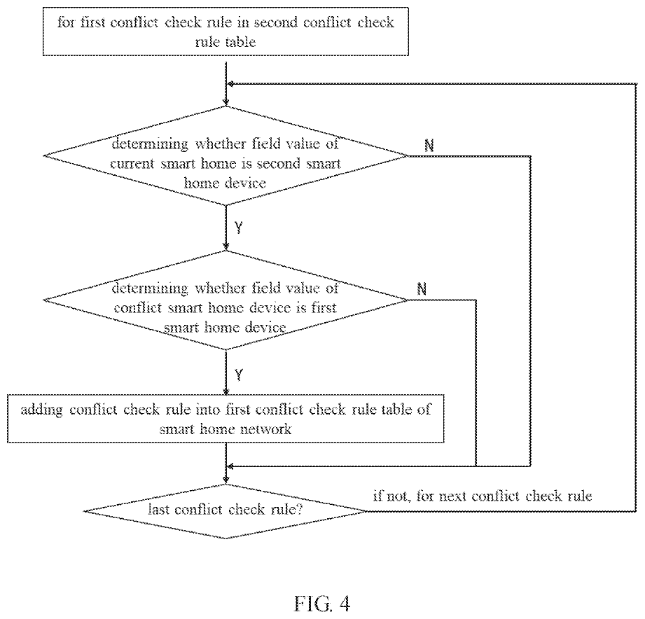

(2) for the first conflict check rule in the second conflict check rule table, performing a third judgment, that is, determining whether the field value of the current smart home is the second smart home device; if the result of the third judgment is no, continuing to make the third judgment for the next conflict check rule until all conflict check rules are determined; and if the result of the first judgment is yes, performing a fourth judgment, that is, determining whether the field value of the conflict smart home device is the first smart home device, if the result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined, and the specific execution processes of the above step are referred to FIG. 4.

In another embodiment, step 104 specifically includes the following two steps:

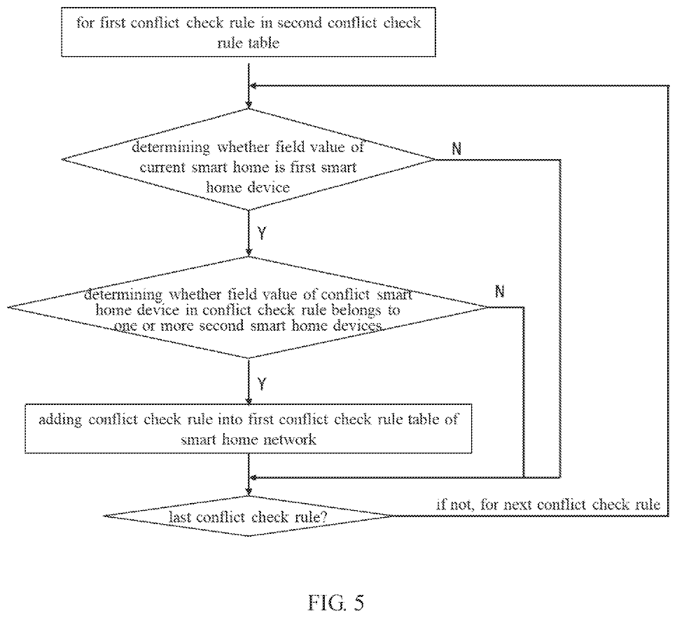

(1) for the first conflict check rule in the second conflict check rule table, performing a first judgment, that is, determining whether the field value of the current smart home is the first smart home device, if the result of the first judgment is no, continuing to make the first judgment for the next conflict check rule until all conflict check rules are determined; and if the result of the first judgment is yes, performing a second judgment, that is, determining whether the value of the conflict smart home device in the conflict check rule belongs to the one or more second smart home devices, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule, until all conflict check rules are determined, the specific execution processes of the above step are referred to FIG. 5; and

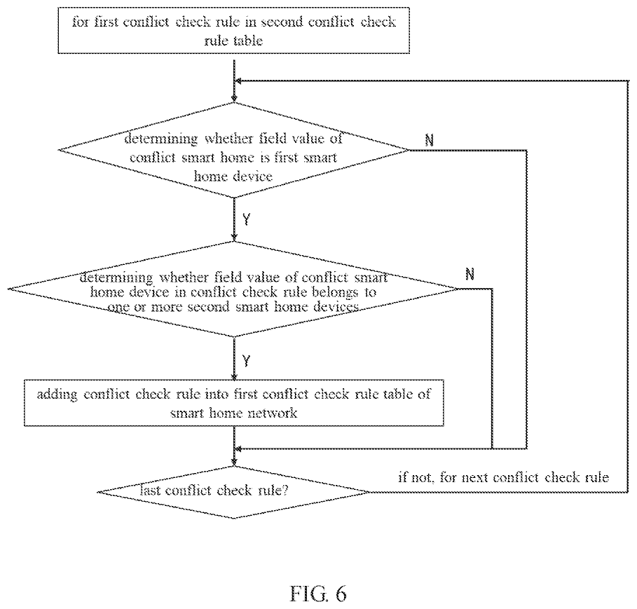

(2) for the first conflict check rule in the second conflict check rule table, performing a third judgment, that is, determining whether the field value of the conflict smart home is the first smart home device, if the result of the third judgment is no, continuing to make the third judgment for the next conflict check rule until all conflict check rules are determined; and if the result of the third judgment is yes, performing a fourth judgment, that is, determining whether the value of the current smart home device in the conflict check rule belongs to the one or more second smart home devices, if the result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined, the specific execution processes of the above step are referred to FIG. 6.

Preferably, the second conflict check rule table and the first conflict check rule table have the same data structure.

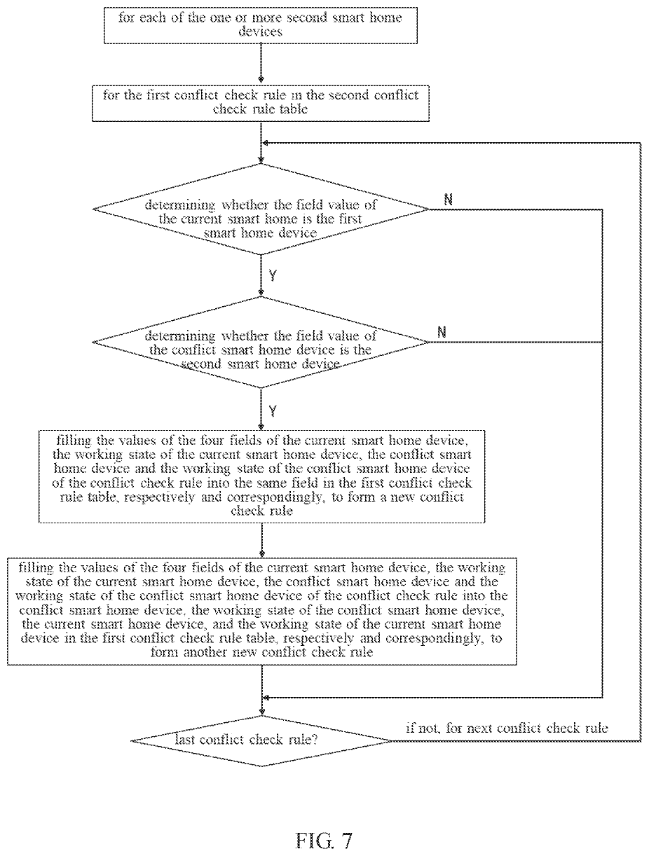

When the second conflict check rule table and the first conflict check rule table have the same data structure, in an embodiment, referring to FIG. 7, step 104 is specifically: for each of the one or more second smart home devices obtained in step 103, performing the following steps:

for the first conflict check rule in the second conflict check rule table, performing a first judgment, that is, determining whether the field value of the current smart home is the first smart home device; if the result of the first judgment is no, continuing to make the first judgment for the next conflict check rule until all conflict check rules are determined; and if the result of the first judgment is yes, performing the second judgment, that is, determining whether the field value of the conflict smart home device is the second smart home device, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;

wherein, adding the conflict check rule into the first conflict check rule table of the smart home network specifically includes:

filling the values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

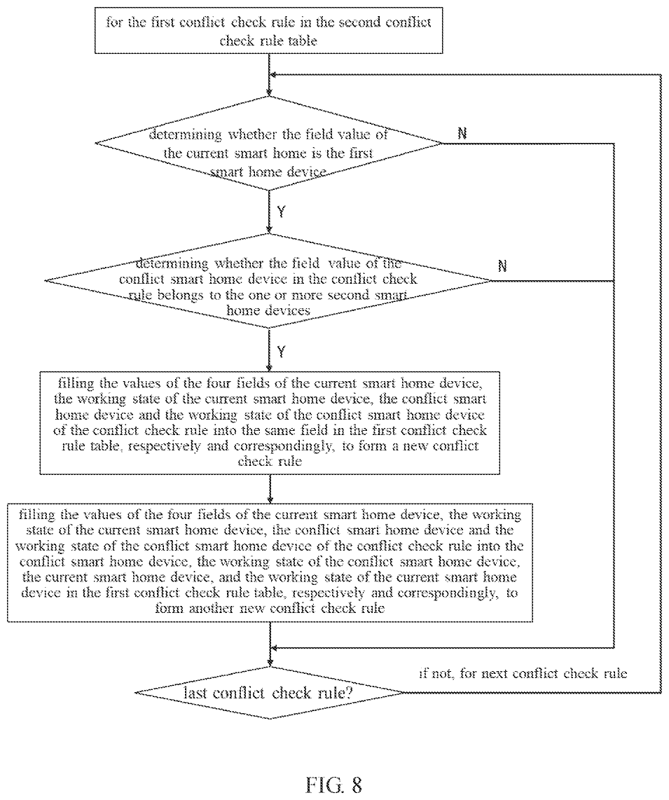

When the second conflict check rule table and the first conflict check rule table have the same data structure, in another embodiment, referring to FIG. 8, step 104 is specifically:

for the first conflict check rule in the second conflict check rule table, performing a first judgment, that is, determining whether the field value of the current smart home is the first smart home device, and if the result of the first judgment is no, continuing to make the first judgment for the next conflict check rule until all conflict check rules are determined; and if the result of the first judgment is yes, performing a second judgment, that is, determining whether the value of the conflict smart home device in the conflict check rule belongs to the one or more second smart home devices, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;

wherein, adding the conflict check rule into the first conflict check rule table of the smart home network specifically includes:

filling the values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

Preferably, the second conflict check rule table and the first conflict check rule table may also have different data structures, at this time, the cloud server needs to perform a format conversion before adding the check rules in the second conflict check rule table to the first conflict check rule table.

In another embodiment, after step 102 and before step 103, it is determined whether the first smart home device is the first smart home device having accessed to the smart home network, if so, the cloud server generates an empty first conflict check rule table for the smart home network, and the execution of the method ends; if not, the processing proceeds to step 103.

In another embodiment, after step 104, if the user issues an instruction, before sending the instruction to the smart home device corresponding to the instruction, the cloud server determines at first whether the state of the smart home device, after executing the instruction, conflicts with the current states of other smart home devices in the current smart home network, according to the first conflict check rule table of the smart home network, if the judgment result is that there is no conflict, the cloud server processes the instruction according to the normal process, that is, sends an instruction to the smart home device, if the judgment result is that there is a conflict, at this time, the cloud server can prompt the user that “the instructions conflict”, and ask the user whether to perform the suggested operation, if the user chooses yes, the corresponding smart home device is controlled according to the suggested operation.

It should be noted that the smart home device does not have a definite corresponding relationship with the first smart home device and the second smart home device, for example, the air conditioner accesses the smart home network for the first time, and is the first smart home device having accessed the smart home network, the air conditioner is the first smart home device, and the second smart home device is empty at this time; after that, the humidifier accesses the smart home network, and at this time, the humidifier is the first smart home device, and the air conditioner is the second smart home device; after that, the air purifier accesses the smart home network, and at this time, the air purifier is the first smart home device, and the air conditioner and the humidifier are the second smart home devices.

The method for dynamically building a conflict check rule table in the smart home of the present disclosure will be described below in conjunction with specific scenarios.

The scenario is defined as follows: only one second smart home device, that is windows/doors, is accessed in the smart home network, the first smart home device is an air conditioner, and the second conflict check rule table uses the data structure of Table 1.

After performing steps 101 to 102, the air conditioner successfully accesses the smart home network, and then in step 103, the cloud server obtains a second smart home device, that is, the windows/doors.

The specific execution process of step 104 is:

for the second smart home device, that is, windows/doors, referring to FIG. 3, according to the aforementioned Table 1, the first judgment is performed, by the cloud server, for the first conflict check rule with a serial number 1, that is, it is determined whether the field value of the current smart home thereof is the first smart home device, in this scenario, if the result of the first judgment is yes, the second judgment is performed, that is, it is determined whether the field value of the conflict smart home device thereof is the second smart home device, in this scenario, if the result of the second judgment is yes, the first conflict check rule with the serial number 1 is added to the first conflict check rule table of the smart home network, and the first judgment is performed continuously for the second conflict check rule with a serial number 2, in this scenario, for the second conflict check rule, the result of the first judgment is yes, and the result of the second judgment is yes, then the second conflict check rule with the serial number 2 is added to the first conflict check rule table of the smart home network, and the first judgment is performed continuously for the second conflict check rule with a serial number 3, and so on, until all conflict check rules in the second conflict check rule table are determined. In this scenario, the result of the execution is to add the conflict check rules with the serial numbers 1 to 3 to the first conflict check rule table of the smart home network. Similarly, the cloud server makes the third judgment and the possible fourth judgment for each conflict check rule, in this scenario, the execution result is to add the conflict check rules with the serial numbers 4 to 6 to the first conflict check rule table of the smart home network.

So far, the method for dynamically building a conflict check rule table in the smart home of the present disclosure has been executed. Subsequently, when the user issues an instruction to turn on the air conditioner and make it in a cooling state, the cloud server determines at first whether the state of the air conditioner after executing the instruction conflicts with the current states of other smart home devices in the smart home network, according to the first conflict check rule table of the smart home network, before sending the instruction to the air conditioner, for example, if the states of doors and windows currently recorded in the cloud server are both close, the judgment result is that there is no conflict, at this time, the cloud server handles the instruction according to the normal process, that is, sends instructions of turning on and cooling to the air conditioner, but if the state of the windows in the current smart home network recorded in the cloud server is an open state, the judgment result is that the conflict occurs, at this time, the cloud server can prompt the user “the current windows are in an open state, which conflicts with the instruction, whether to continue to turn on the air conditioner and close the window”, if the user chooses yes, the cloud server sends a close instruction to the window, and sends the turning on and cooling instructions to the air conditioner, thereby avoiding wasting power and reducing the service life of the smart home devices, and further improving the user experience.

In addition, when the method of the present disclosure updates specifically the first conflict check rule table of the smart home network, it is only considered whether the smart home device having accessed the network conflicts with the smart device by searching, the smart home devices that conflict with the smart home device but do not exist in the current smart home network are not recorded in the first conflict check rule table of the smart home network, specifically, in the above scenario, in the second conflict check rule table of the cloud server, there is also a humidifier in the smart home devices conflicting with the air conditioner, but the smart home devices having accessed the smart home network do not include a humidifier, therefore, the generated first conflict check rule table does not include the conflict check rule between the air conditioner and the humidifier, such that unnecessary conflict check can be avoided when the user issues an instruction to control the smart home devices, thereby accelerating the response speed of the conflict check, and further improving the user experience.

The above description is made by only taking the number of the second smart home devices having accessed the smart home network as 1, and when the number of the second smart home devices is multiple, the execution process is similar, and will not be repeated here.

The above description is made by only taking the first specific implementation process of step 104 as an example, and other specific implementation processes of step 104 can also be used to obtain the same first conflict check rule table of the current smart home network, and will not be repeated here.

The above description is made by only taking the data structure of Table 1 used by the second conflict check rule table as an example, and the data structure of Table 2 used by the second conflict check rule table has a similar execution process, and will not be repeated here.

The second conflict check rule table stored in the cloud server will be described as follows.

In an embodiment, the cloud server obtains the first conflict check rule tables of other smart home networks, and de-duplicates and sorts the first conflict check rule tables of other smart home networks to form a second conflict check rule table. Herein, the first conflict check rule tables of other smart home networks may be generated by the cloud server according to the smart home device function table stored in the cloud server, the specific generation process is similar as the process of generating the conflict check rule in the second conflict check rule table according to the smart home device function table, as described below in this disclosure, and the first conflict check rule tables of other smart home networks may also be set by users according to their personalized requirements; and the first conflict check rule table of the other smart home networks may also be a first conflict check rule table obtained by the user by adding, according to their personalized requirements, one or more conflict check rules based on the above-mentioned first conflict check rule generated by the cloud server.

Taking the second conflict check rule table and the first conflict check rule table having the same data structure as an example, for example, the cloud server obtains the first conflict check rule table A of the smart home network A (referring to Table 3), obtains the first conflict check rule table B of the smart home network B (referring to Table 4), and forms the second conflict check rule table shown in Table 1 through de-duplicating and sorting.

TABLE 3
First Conflict Check Rule Table A

| | | Working State of | | Working State of |
|---|---|---|---|---|
| Serial | Current Smart | Current Smart | Conflict Smart | Conflict Smart |
| Number | Home Device | Home Device | Home Device | Home Device |
| 1 | Air conditioner | Cooling | Windows/Doors | Open |
| 2 | Air conditioner | Heating | Windows/Doors | Open |
| 3 | Air conditioner | Dehumidification | Windows/Doors | Open |
| 4 | Windows/Doors | Open | Air conditioner | Cooling |
| 5 | Windows/Doors | Open | Air conditioner | Heating |
| 6 | Windows/Doors | Open | Air conditioner | Dehumidification |
| 7 | Projector | Turning on | Lamp | Turning on |
| 8 | Lamp | Turning on | Projector | Turning on |

TABLE 4
First Conflict Check Rule Table B

| | | Working State of | | Working State of |
|---|---|---|---|---|
| Serial | Current Smart | Current Smart | Conflict Smart | Conflict Smart |
| Number | Home Device | Home Device | Home Device | Home Device |
| 1 | Air conditioner | Cooling | Windows/Doors | Open |
| 2 | Air conditioner | Heating | Windows/Doors | Open |
| 3 | Air conditioner | Dehumidification | Windows/Doors | Open |
| 4 | Windows/Doors | Open | Air conditioner | Cooling |
| 5 | Windows/Doors | Open | Air conditioner | Heating |
| 6 | Windows/Doors | Open | Air conditioner | Dehumidification |
| 7 | Air conditioner | Dehumidification | Humidifier | Turning on |
| 8 | Humidifier | Turning on | Air conditioner | Dehumidification |
| 9 | Humidifier | Turning on | Windows/Doors | Open |
| 10 | Windows/Doors | Open | Humidifier | Turning on |

In the process of using the smart home network, the user is given the permission to edit the first conflict check rule table, that is, the user can add or delete the first conflict check rule table of the smart home network, for example, users of the smart home network A may give their projector to a friend, and delete the conflict check rules related to the projector from the first conflict check rule table, that is, delete the conflict check rules with the serial numbers 7 and 8 in Table 3, but considering that other users may still need the above conflict check rules, therefore, the above deletion operation of the user of the smart home network A will not cause the cloud server to delete the corresponding conflict check rules in the second conflict check rule table. That is, for the user's deletion operation, the cloud server does not update the second conflict check rule table, but only updates the second conflict check rule table in the case that the user adds a conflict check rule. Specifically, in an embodiment, the cloud server regularly queries whether a new conflict check rule has been added to the first conflict check rule table of all smart home networks, and if so, the new conflict check rule is added to the second conflict check rule table. In another embodiment, when the cloud server has detected that a new conflict check rule is added to the first conflict check rule table of a certain smart home network, the new conflict check rule is added to the second conflict check rule table in real time.

In this embodiment, in the process of generating the first conflict check rule table, the cloud server has used the conflict check rules already generated by other smart home networks, that is, for a new conflict check rule, at most only one user is required for manual setting or no user is required for manual setting (when the first conflict check rule table is generated according to the smart home device function table), thereby avoiding that different users need to manually set the same or similar conflict check rules, and providing a dynamic and real-time way of generating conflict check rules for users, which improves user experience.

In another embodiment, the cloud server obtains the first conflict check rule tables of other smart home networks, de-duplicates and sorts the first conflict check rule tables of other smart home networks, and then forms the second conflict check rule table by de-duplicating, in addition, a smart home device function table is stored in the cloud server, according to the smart home device function table, a second conflict check rule supplementary table is generated by the cloud server, and the second conflict check rule table is updated according to the second conflict check rule supplementary table.

Referring to Table 5, each row of the smart home device function table corresponds to a function of a smart home device, and each row includes the following fields: a smart home device, a working state, an influencing parameter, and an influencing result; wherein, the functions of the smart home devices are represented by two fields of the influencing parameter and the influencing result.

TABLE 5
Smart Home Device Function Table

| Serial | | Influencing | Influencing | |
|---|---|---|---|---|
| Number | Smart Home Device | Parameter | Result | Working State |
| 1 | Air conditioner | Temperature | Increase | Heating |
| 2 | Air conditioner | Temperature | Reduce | Cooling |
| 3 | Air conditioner | Humidity | Reduce | Dehumidification |
| 4 | Humidifier | Humidity | Increase | Turning on |
| 5 | Air purifier | Air quality | Improve | Turning on |
| 6 | Windows/Doors | Temperature | Increase | Open |
| 7 | Windows/Doors | Temperature | Reduce | Open |
| 8 | Windows/Doors | Humidity | Increase | Open |
| 9 | Windows/Doors | Humidity | Reduce | Open |
| 10 | Windows/Doors | Air quality | Reduce | Open |

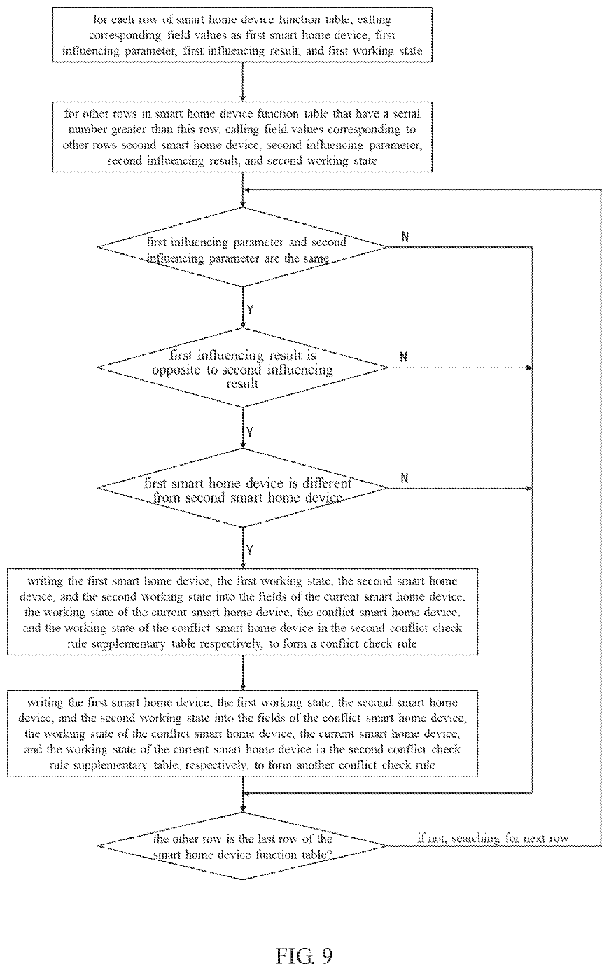

According to the smart home device function table, the specific process of generating the second conflict check rule supplementary table by the cloud server is as follows: referring to FIG. 9, the cloud server performs the following steps for each row of the smart home device function table: calling the corresponding field values as a first smart home device, a first influencing parameter, a first influencing result, and a first working state, and determining whether there are other rows in the smart home device function table that have a serial number greater than this row and meet the following conditions, the field values corresponding to the other rows being called a second smart home device, a second influencing parameter, a second influencing result, and a second working state:

1. the first influencing parameter and the second influencing parameter are the same;

2. the first influencing result is opposite to the second influencing result; and

3. the first smart home device is different from the second smart home device;

if there are such other rows, writing the first smart home device, the first working state, the second smart home device, and the second working state into the fields of the current smart home device, the working state of the current smart home device, the conflict smart home device, and the working state of the conflict smart home device in the second conflict check rule supplementary table, respectively, to form a new conflict check rule, and writing the first smart home device, the first working state, the second smart home device, and the second working state into the fields of the conflict smart home device, the working state of the conflict smart home device, the current smart home device, and the working state of the current smart home device in the second conflict check rule supplementary table, respectively, to form another new conflict check rule.

For example, for the first row in Table 5, the seventh row is the other row that meets the above three conditions, that is, “air conditioner”, “heating”, “windows/doors”, and “open” are written in sequence into the four fields in the first row of the second conflict check rule supplementary table, and “air conditioner”, “heating”, “windows/doors”, and “open” are written respectively into the fields of the conflict smart home device, the working state of the conflict smart home device, the current smart home device, and the working state of the current smart home device in the second row of the second conflict check rule supplementary table, and so on, such that the second conflict check rule table formed by the smart home device function table in Table 5 is as shown in Table 6.

TABLE 6
Second Conflict Check Rule Supplementary Table

| | | Working State of | | Working State of |
|---|---|---|---|---|
| Serial | Current Smart | Current Smart | Conflict Smart | Conflict Smart |
| Number | Home Device | Home Device | Home Device | Home Device |
| 1 | Air conditioner | Heating | Windows/Doors | Open |
| 2 | Windows/Doors | Open | Air conditioner | Heating |
| 3 | Air conditioner | Cooling | Windows/Doors | Open |
| 4 | Windows/Doors | Open | Air conditioner | Cooling |
| 5 | Air conditioner | Dehumidification | Humidifier | Turning on |
| 6 | Humidifier | Turning on | Air conditioner | Dehumidification |
| 7 | Air conditioner | Dehumidification | Windows/Doors | Open |
| 8 | Windows/Doors | Open | Air conditioner | Dehumidification |
| 9 | Humidifier | Turning on | Windows/Doors | Open |
| 10 | Windows/Doors | Open | Humidifier | Turning on |
| 11 | Air purifier | Turning on | Windows/Doors | Open |
| 12 | Windows/Doors | Open | Air purifier | Turning on |

Preferably, updating the second conflict check rule table according to the second conflict check rule supplementary table specifically includes: determining whether the conflict check rules in the second conflict check rule supplementary table are contained in the second conflict check rule table, if not, adding them into the second conflict check rule table. In the above-mentioned embodiments, the conflict check rules with the serial numbers 11 to 12 in Table 6 are added to the second conflict check rule table.

Preferably, the smart home device function table is updated regularly or in real time according to the product catalog and product manual of each smart home device manufacturer. As a result, for new smart home devices, the cloud server can also generate conflict check rules involving the smart home devices without the user's manual setting, and thus the conflict check can also be performed for the smart home devices, thereby improving the user experience.

The embodiments of the present disclosure provide an apparatus for dynamically building a conflict check rule table in smart home, and the apparatus includes:

an access request receiving module, configured to receive a smart home network access request sent by a first smart home device when the first smart home device accesses the smart home network for the first time;

an access response sending module, configured to return an access response to the first smart home device, and establish a connection with the first smart home device, to enable the first smart home device to successfully access the smart home network;

a first obtaining module, configured to obtain one or more second smart home devices having accessed the smart home network;

a dynamic building module, configured to search for a second smart home device conflicting with the first smart home device in the one or more second smart home devices according to a second conflict check rule table, and add a search result to a first conflict check rule table corresponding to the smart home network; and

a first storage module, configured to store the second conflict check rule table;

wherein the first conflict check rule table is used specifically to: when receiving a user's instruction for a certain smart home device, before specifically executing the instruction, determine at first whether a state of the smart home device conflicts with the states of other smart home devices after the instruction is executed, and execute the instruction when there is no conflict.

Preferably, the apparatus further comprises a second storage module having stored therein a smart home device list of the smart home network in which one or more second smart home devices having accessed the smart home network are stored; and

the first obtaining module is configured to obtain one or more second smart home devices having accessed the smart home network according to the smart home device list.

Preferably, the dynamic building module is configured to search in a second conflict check rule table whether there is a conflict check rule involving the first smart home device and the one or more second smart home devices, and if so, add the conflict check rule into the first conflict check rule table of the smart home network.

Preferably, the second conflict check rule table includes one or more conflict check rules, and each conflict check rule corresponds to a row of the table, including four fields of a current smart home device, a working state of the current smart home device, a conflict smart home device and a working state of the conflict smart home device.

Preferably, the dynamic building module is specifically configured to perform the following steps for each of the one or more second smart home devices obtained by the first obtaining module:

for the first conflict check rule in the second conflict check rule table, performing a first judgment, that is, determining whether a field value of the current smart home is the first smart home device; if the result of the first judgment is no, continuing to make the first judgment for the next conflict check rule until all conflict check rules are determined; and if the result of the first judgment is yes, performing a second judgment, that is, determining whether the field value of the conflict smart home device is the second smart home device, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined; and

for the first conflict check rule in the second conflict check rule table, performing a third judgment, that is, determining whether the field value of the current smart home is the second smart home device; if the result of the third judgment is no, continuing to make the third judgment for the next conflict check rule until all conflict check rules are determined; and if the result of the first judgment is yes, performing a fourth judgment, that is, determining whether the field value of the conflict smart home device is the first smart home device, if the result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined.

Preferably, the dynamic building module is specifically configured to:

for the first conflict check rule in the second conflict check rule table, perform a first judgment, that is, determine whether the field value of the current smart home is the first smart home device, if the result of the first judgment is no, continue to make the first judgment for the next conflict check rule until all conflict check rules are determined; and if the result of the first judgment is yes, perform a second judgment, that is, determine whether the value of the conflict smart home device in the conflict check rule belongs to the one or more second smart home devices, if the result of the second judgment is yes, add the conflict check rule into the first conflict check rule table of the smart home network, and continue to make the first judgment for the next conflict check rule until all conflict check rules are determined, and if the result of the second judgment is no, continue to make the first judgment for the next conflict check rule, until all conflict check rules are determined; and

for the first conflict check rule in the second conflict check rule table, perform a third judgment, that is, determine whether the field value of the conflict smart home is the first smart home device, if the result of the third judgment is no, continue to make the third judgment for the next conflict check rule until all conflict check rules are determined; and if the result of the third judgment is yes, perform a fourth judgment, that is, determine whether the value of the current smart home device in the conflict check rule belongs to the one or more second smart home devices, if the result of the fourth judgment is yes, add the conflict check rule into the first conflict check rule table of the smart home network, and continue to make the third judgment for the next conflict check rule until all conflict check rules are determined, and if the result of the fourth judgment is no, continue to make the third judgment for the next conflict check rule until all conflict check rules are determined.

Preferably, the second conflict check rule table and the first conflict check rule table have the same data structure.

Preferably, the dynamic building module is specifically configured to perform the following processes for each of the one or more second smart home devices obtained by the first obtaining module:

for the first conflict check rule in the second conflict check rule table, performing a first judgment, that is, determining whether the field value of the current smart home is the first smart home device; if the result of the first judgment is no, continuing to make the first judgment for the next conflict check rule until all conflict check rules are determined; and if the result of the first judgment is yes, performing the second judgment, that is, determining whether the field value of the conflict smart home device is the second smart home device, if the result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;

wherein, adding the conflict check rule to the first conflict check rule table of the smart home network specifically includes:

filling the values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

Preferably, the dynamic building module is specifically configured to:

for the first conflict check rule in the second conflict check rule table, perform a first judgment, that is, determine whether the field value of the current smart home is the first smart home device, and if the result of the first judgment is no, continue to make the first judgment for the next conflict check rule until all conflict check rules are determined; and if the result of the first judgment is yes, perform a second judgment, that is, determine whether the value of the conflict smart home device in the conflict check rule belongs to the one or more second smart home devices, if the result of the second judgment is yes, add the conflict check rule into the first conflict check rule table of the smart home network, and continue to make the first judgment for the next conflict check rule until all conflict check rules are determined, and if the result of the second judgment is no, continuing to make the first judgment for the next conflict check rule until all conflict check rules are determined;

wherein, adding the conflict check rule to the first conflict check rule table of the smart home network specifically includes:

filling the values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and

filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

Preferably, the apparatus further includes a second obtaining module and a de-duplicating and sorting module, wherein the second obtaining module is configured to obtain the first conflict check rule tables of other smart home networks; and the de-duplicating and sorting module is configured to de-duplicate and sort the first conflict check rule tables of other smart home networks to form a second conflict check rule table.

Preferably, the apparatus further includes a regularly synchronizing module configured to regularly query whether a new conflict check rule has been added to the first conflict check rule table of all smart home networks, and if so, the new conflict check rule is added into the second conflict check rule table.

Preferably, the apparatus further includes a real-time synchronizing module configured to add, when it is detected that a new conflict check rule is added to the first conflict check rule table of a certain smart home network, the new conflict check rule into the second conflict check rule table in real time.

Preferably, the apparatus further includes a third storage module and a first update module, wherein the third storage module is configured to store a smart home device function table; and

the first update module is configured to generate a second conflict check rule supplementary table by the cloud server according to the smart home device function table, and update the second conflict check rule table according to the second conflict check rule supplementary table.

Preferably, each row of the smart home device function table corresponds to a function of smart home device, and each row comprises the following fields: a smart home device, a working state, an influencing parameter, and an influencing result; wherein the functions of the smart home devices are represented by two fields of the influencing parameter and the influencing result.

Preferably, the first update module is specifically configured to perform the following operations for each row of the smart home device function table:

calling the corresponding field values as a first smart home device, a first influencing parameter, a first influencing result, and a first working state, and determining whether there are other rows in the smart home device function table that have a serial number greater than this row and meet the following conditions, the field values corresponding to the other rows being called a second smart home device, a second influencing parameter, a second influencing result, and a second working state:

(1) the first influencing parameter and the second influencing parameter are the same;

(2) the first influencing result is opposite to the second influencing result; and

(3) the first smart home device is different from the second smart home device;

if there are such other rows, writing the first smart home device, the first working state, the second smart home device, and the second working state into the fields of the current smart home device, the working state of the current smart home device, the conflict smart home device, and the working state of the conflict smart home device in the second conflict check rule supplementary table, respectively, to form a new conflict check rule, and writing the first smart home device, the first working state, the second smart home device, and the second working state into the fields of the conflict smart home device, the working state of the conflict smart home device, the current smart home device, and the working state of the current smart home device in the second conflict check rule supplementary table, respectively, to form another new conflict check rule.

Preferably, the first update module is specifically configured to determine whether the conflict check rules in the second conflict check rule supplementary table are contained in the second conflict check rule table, if not, add them into the second conflict check rule table.

Preferably, the apparatus further includes a second update module, configured to update the smart home device function table regularly or in real time according to a product catalog and product manual of each smart home device manufacturer.

Preferably, the apparatus is located in a cloud server.

The embodiments of the present disclosure provide a system for dynamically building a conflict check rule table in smart home, including one or more smart terminals, the above-mentioned apparatuses, and multiple smart devices.

The embodiments of the present disclosure provide a computer device including a processor and memory, and the memory for storing processor executable computer instructions, and when the processor executes the computer instructions, the above-mentioned methods are implemented.

The embodiments of the present disclosure provide a computer-readable storage medium having stored therein computer instructions for implementing the methods described above.

Any combination of one or more computer-readable medium can be used. The computer-readable medium can be a computer-readable signal medium or a computer-readable storage medium. The computer-readable storage medium can be, for example, but not limited to, an electrical, magnetic, optical, electromagnetic, infrared, or semiconductor system, apparatus, or device, or a combination of any of the above. The computer-readable storage medium may include: an electrical connection with one or more wires, a portable computer disk, a hard disk, random access memory (RAM), read-only memory (ROM), flash memory, erasable programmable read-only memory (EPROM), optical fiber, portable compact disk read-only memory (CD-ROM), optical storage device, magnetic storage device, or any suitable combination of the above. In the present documents, the computer-readable storage medium can be any tangible medium that contains or stores a program, and the program can be used by or in combination with an instruction execution system, apparatus, or device.

The computer program code for performing the operations of the present disclosure can be written in one or more programming languages or a combination thereof

The above description is merely an example to facilitate the understanding of the present disclosure, and is not used to limit the scope of the present disclosure. In the specific implementation, those skilled in the art can change, increase, or reduce the components of the device according to the actual situation, and can change, increase, reduce the steps of the method or change the order of the steps of the method according to the actual situation without affecting the functions realized by the method.

While the embodiments of the present disclosure have been shown and described, those skilled in the art should understand that various variations, alterations, substitutions, and modifications can be made to these embodiments without departing from the principle and purpose of the present disclosure, the scope of the present disclosure is defined by the claims and their equivalent replacements, and improvements made without creative work should be included within the protection scope of the present disclosure.

1. A method for dynamically building a conflict check rule table in smart home, comprising:
sending a smart home network access request to a cloud server, by a first smart home device, when accessing a smart home network for the first time;
returning an access response to the first smart home device by the cloud server, and establishing a connection with the cloud server by the first smart home device to successfully access the smart home network;
obtaining one or more second smart home devices having accessed the smart home network by the cloud server; and
searching for a second smart home device conflicting with the first smart home device in the one or more second smart home devices according to a second conflict check rule table stored therein, and adding a search result to a first conflict check rule table corresponding to the smart home network, by the cloud server;
wherein the first conflict check rule table is used to: when receiving a user's instruction for a certain smart home device, prior to executing the instruction, determine at first whether a state of the smart home device conflicts with states of other smart home devices after the instruction is executed, and execute the instruction when there is no conflict.

2. The method according to claim 1, wherein:
a smart home device list of the smart home network is stored in the cloud server, one or more second smart home devices having accessed the smart home network are stored in the smart home device list, and the one or more second smart home devices having accessed the smart home network are obtained by the cloud server according to the smart home device list.

3. The method according to claim 1, wherein the searching for a second smart home device conflicting with the first smart home device in the one or more second smart home devices comprises:
searching in a second conflict check rule table whether there is a conflict check rule involving the first smart home device and the one or more second smart home devices, and if so, adding the conflict check rule into the first conflict check rule table of the smart home network.

4. The method according to claim 3, wherein the second conflict check rule table comprises one or more conflict check rules, and each conflict check rule corresponds to a row of the table, comprising four fields of a current smart home device, a working state of the current smart home device, a conflict smart home device and a working state of the conflict smart home device.

5. The method according to claim 4, wherein searching for the second smart home device conflicting with the first smart home device in the one or more second smart home devices, and adding the search result to the first conflict check rule table corresponding to the smart home network comprises:
performing the following steps for each of the obtained one or more second smart home devices:
for the first conflict check rule in the second conflict check rule table, performing a first judgment, that is, determining whether a field value of the current smart home is the first smart home device; if a result of the first judgment is no, continuing to make the first judgment for a next conflict check rule until all conflict check rules are determined; and if the result of the first judgment is yes, performing a second judgment, that is, determining whether a field value of the conflict smart home device is the second smart home device, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined; and
for the first conflict check rule in the second conflict check rule table, performing a third judgment, that is, determining whether the field value of the current smart home is the second smart home device; if a result of the third judgment is no, continuing to make the third judgment for the next conflict check rule until all conflict check rules are determined; and if the result of the third judgment is yes, performing a fourth judgment, that is, determining whether the field value of the conflict smart home device is the first smart home device, if a result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined.

6. The method according to claim 4, wherein searching for the second smart home device conflicting with the first smart home device in the one or more second smart home devices, and adding the search result to the first conflict check rule table corresponding to the smart home network comprises:
for the first conflict check rule in the second conflict check rule table, performing a first judgment, that is, determining whether a field value of the current smart home is the first smart home device, if a result of the first judgment is no, continuing to make the first judgment for a next conflict check rule until all conflict check rules are determined; and if the result of the first judgment is yes, performing a second judgment, that is, determining whether a value of the conflict smart home device in the conflict check rule belongs to the one or more second smart home devices, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule, until all conflict check rules are determined; and
for the first conflict check rule in the second conflict check rule table, performing a third judgment, that is, determining whether a field value of the conflict smart home is the first smart home device, if a result of the third judgment is no, continuing to make the third judgment for the next conflict check rule until all conflict check rules are determined; and if the result of the third judgment is yes, performing a fourth judgment, that is, determining whether a value of the current smart home device in the conflict check rule belongs to the one or more second smart home devices, if a result of the fourth judgment is yes, adding the conflict check rule into the first conflict check rule table of the smart home network, and continuing to make the third judgment for the next conflict check rule until all conflict check rules are determined, and if the result of the fourth judgment is no, continuing to make the third judgment for the next conflict check rule until all conflict check rules are determined.

7. The method according to claim 4, wherein:
the second conflict check rule table and the first conflict check rule table have the same data structure.

8. The method according to claim 7, wherein searching for the second smart home device conflicting with the first smart home device in the one or more second smart home devices, and adding the search result to the first conflict check rule table corresponding to the smart home network comprises:
performing the following steps for each of the obtained one or more second smart home devices:
for the first conflict check rule in the second conflict check rule table, performing a first judgment, that is, determining whether a field value of the current smart home is the first smart home device; if a result of the first judgment is no, continuing to make the first judgment for a next conflict check rule until all conflict check rules are determined; and if the result of the first judgment is yes, performing a second judgment, that is, determining whether a field value of the conflict smart home device is the second smart home device, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;
wherein, adding the conflict check rule into the first conflict check rule table of the smart home network comprises:
filling values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,
filling the values of the four fields of the current smart home device, the working state of the current smart home device, the conflict smart home device and the working state of the conflict smart home device of the conflict check rule into the fields of the conflict smart home device, the working state of the conflict smart home device, the current smart home device, and the working state of the current smart home device in the first conflict check rule table, respectively and correspondingly, to form another new conflict check rule.

9. The method according to claim 7, wherein searching for the second smart home device conflicting with the first smart home device in the one or more second smart home devices, and adding the search result to the first conflict check rule table corresponding to the smart home network comprises:
for the first conflict check rule in the second conflict check rule table, performing a first judgment, that is, determining whether a field value of the current smart home is the first smart home device, and if a result of the first judgment is no, continuing to make the first judgment for a next conflict check rule until all conflict check rules are determined; and if the result of the first judgment is yes, performing a second judgment, that is, determining whether a value of the conflict smart home device in the conflict check rule belongs to the one or more second smart home devices, if a result of the second judgment is yes, adding the conflict check rule into the first conflict check rule table of the smart home network, and continuing to make the first judgment for the next conflict check rule until all conflict check rules are determined, and if the result of the second judgment is no, continuing to make the first judgment for the next conflict check rule until all conflict check rules are determined;
wherein, adding the conflict check rule into the first conflict check rule table of the smart home network comprises:
filling values of the four fields of the current smart home device, the working state of the current smart home device, the conflict smart home device and the working state of the conflict smart home device of the conflict check rule into the same field in the first conflict check rule table, respectively and correspondingly, to form a new conflict check rule; and,
filling the values of the four fields of the current smart home device, the working state of the current smart home device, the conflict smart home device and the working state of the conflict smart home device of the conflict check rule into the conflict smart home device, the working state of the conflict smart home device, the current smart home device, and the working state of the current smart home device in the first conflict check rule table, respectively and correspondingly, to form another new conflict check rule.

10. The method according to claim 1, wherein:
the cloud server obtains the first conflict check rule tables of other smart home networks, and de-duplicates and sorts the first conflict check rule tables of other smart home networks to form a second conflict check rule table.

11. The method according to claim 10, wherein:
the cloud server regularly queries whether a new conflict check rule has been added to the first conflict check rule table of all smart home networks, and if so, the new conflict check rule is added into the second conflict check rule table.

12. The method according to claim 10, wherein:
when the cloud server has detected that a new conflict check rule is added to the first conflict check rule table of a certain smart home network, the new conflict check rule is added into the second conflict check rule table in real time.

13. The method according to claim 10, wherein:
a smart home device function table is stored in the cloud server, a second conflict check rule supplementary table is generated by the cloud server according to the smart home device function table, and the second conflict check rule table is updated according to the second conflict check rule supplementary table.

14. The method according to claim 13, wherein:
each row of the smart home device function table corresponds to a function of a smart home device, and each row comprises the following fields: a smart home device, a working state, an influencing parameter, and an influencing result; wherein the functions of the smart home devices are represented by two fields of the influencing parameter and the influencing result.

15. The method according to claim 14, wherein generating the second conflict check rule supplementary table by the cloud server according to the smart home device function table is as follows:
performing the following steps by the cloud server for each row of the smart home device function table:
calling corresponding field values as a first smart home device, a first influencing parameter, a first influencing result, and a first working state, and determining whether there are other rows in the smart home device function table that have a serial number greater than this row and meet the following conditions, the field values corresponding to the other rows being called a second smart home device, a second influencing parameter, a second influencing result, and a second working state:
(1) the first influencing parameter and the second influencing parameter are the same;
(2) the first influencing result is opposite to the second influencing result; and
(3) the first smart home device is different from the second smart home device;
if there are such other rows, writing the first smart home device, the first working state, the second smart home device, and the second working state into the fields of the current smart home device, the working state of the current smart home device, the conflict smart home device, and the working state of the conflict smart home device in the second conflict check rule supplementary table, respectively, to form a conflict check rule, and writing the first smart home device, the first working state, the second smart home device, and the second working state into the fields of the conflict smart home device, the working state of the conflict smart home device, the current smart home device, and the working state of the current smart home device in the second conflict check rule supplementary table, respectively, to form another conflict check rule.

16. The method according to claim 13, wherein:
updating the second conflict check rule table according to the second conflict check rule supplementary table is as follows: determining whether the conflict check rules in the second conflict check rule supplementary table are contained in the second conflict check rule table, if not, adding them into the second conflict check rule table.

17. The method according to claim 13, wherein:
the smart home device function table is updated regularly or in real time according to a product catalog and product manual of each smart home device manufacturer.

18. An apparatus for dynamically building a conflict check rule table in smart home, comprising:
a memory device for storing processor executable instructions;
a processor configured to:
receive a smart home network access request sent by a first smart home device when the first smart home device accesses the smart home network for the first time;
return an access response to the first smart home device, and establish a connection with the first smart home device, to enable the first smart home device to successfully access the smart home network;
obtain one or more second smart home devices having accessed the smart home network;
search for a second smart home device conflicting with the first smart home device in the one or more second smart home devices according to a second conflict check rule table, and add a search result to a first conflict check rule table corresponding to the smart home network; and
store the second conflict check rule table;
wherein the first conflict check rule table is used to: when receiving a user's instruction for a certain smart home device, prior to executing the instruction, determine at first whether a state of the smart home device conflicts with states of other smart home devices after the instruction is executed, and execute the instruction when there is no conflict.

19. A system for dynamically building a conflict check rule table in smart home, comprising one or more smart terminals, the apparatus according to claim 18, and multiple smart devices.

20. A computer-readable storage medium having stored therein computer instructions for implementing the method according to claim 1.
